(19) United States
(12) Patent Application Publication
(10) Pub. No.: US 2025/0273780 A1
(43) Pub. Date: Aug. 28, 2025

(54) METHOD FOR MANUFACTURING A POWER STORAGE DEVICE

(71) Applicant: Prime Planet Energy & Solutions, Inc., Tokyo (JP)

(72) Inventor: Yusuke OKUHATA, Toyota-shi (JP)

(21) Appl. No.: 19/015,633

(22) Filed: Jan. 10, 2025

(30) Foreign Application Priority Data
Feb. 27, 2024 (JP) 2024-027820

(51) Int. Cl. H01M 50/169; H01M 10/0587; H01M 50/102; H01M 50/119; H01M 50/148; H01M 50/159

(52) U.S. Cl. CPC H01M 50/169; H01M 10/0587; H01M 50/119; H01M 50/159; H01M 50/102; H01M 50/148

(57) ABSTRACT

A method for manufacturing a power storage device, in which an outer circumferential edge portion of a lid and an opening portion of a case body are welded via a melted-solidified portion, includes: a placing step of placing the lid in an unmelted opening portion of the case body; a welding step of welding the outer circumferential edge portion 36 of the lid 33 and the opening portion of the case body over their entire circumference. In the placing step, the unmelted opening portion of the case body is placed on a lower side more than a circumferential edge upper surface of the unmelted outer circumferential edge portion of the lid. In the welding step, laser welding is performed by irradiating a multi-beam of a beamlet pattern that provides more heat input to the unmelted opening portion compared to the unmelted outer circumferential edge portion.

### CROSS-REFERENCE TO RELATED APPLICATIONS

This application is based upon and claims the benefit of priority to Japanese Patent Application No. 2024-027820 filed on Feb. 27, 2024, the entire contents of which are incorporated herein by reference.

### BACKGROUND

### Technical Field

The disclosure relates to a method for manufacturing a power storage device in which an opening portion of a case body and an outer circumferential edge portion of a lid are welded to each other by laser welding.

### Related Art

Japanese unexamined patent application publication No. 2019-084540 (JP 2019-084540A) discloses the technique that for welding an opening portion of a case body and an outer circumferential edge portion of a lid using a laser beam including a plurality of beamlets, which is a so-called a multi-beam, the intensity of a laser beamlet(s) to be irradiated to the opening portion of the case body is set higher than that of a laser beamlet to be irradiated to the outer circumferential edge portion of the lid. This is to form a molten portion with an upper surface inclined to be lower on the case body side than the lid side so that the reflected light of the laser beam impinging on this molten portion travels outward, preventing or reducing thermal deterioration of an insulation resin member caused by irradiation of the reflected light of the laser beam onto the insulation resin member.

### SUMMARY

### Technical Problems

In this publication No. JP 2019-084540A, as described in its FIG. 2, the case body and the lid are placed so that the upper end face of the opening portion of the case body is positioned at a higher side, or position, than the upper surface of the outer circumferential edge portion of the lid. Accordingly, even if the intensity of a laser beamlet to be irradiated to the opening portion of the case body is set higher than that of a laser beamlet to be irradiated to the outer circumferential edge portion of the lid to form a molten portion, this formed molten portion is unlikely to have the shape shown in FIG. 4 of JP 2019-084540A, and may have an upward bulging, or raised, shape, thus causing a reflected light of a laser beamlet irradiated thereto to travel inward and irradiated the insulation resin member, resulting in thermal deterioration of the insulation resin member.

The present disclosure has been made to address the above problems and has a purpose to provide a method for manufacturing a power storage device, capable of reliably preventing or reducing the occurrence of thermal deterioration, such as scorch, of an insulation resin member caused by a reflected light of a laser beamlet traveling inward during laser welding.

### Means of Solving the Problems

(1) To achieve the above-mentioned purpose, one aspect of the present disclosure provides a method for manufacturing a power storage device comprising: a case member made of metal; and an electrode body housed in the case member, the case member including: a case body having a tube shape with an opening portion; a lid having a flat plate shape, placed in the opening portion of the case body, the lid including: an outer circumferential edge portion; and an inside portion located more inside than the outer circumferential edge portion, a recessed groove, which is depressed in a lid upper surface between the outer circumferential edge portion and the inside portion; and an insulation resin member placed on the lid upper surface of the inside portion of the lid, and the outer circumferential edge portion of the lid and the opening portion of the case body are welded to each other over an entire circumference via a melted-solidified portion formed by a part of the outer circumferential edge portion and a part of the opening portion that are melted together and then solidified, wherein the method comprises: placing the lid in an unmelted opening portion of the case body; and welding the outer circumferential edge portion of the lid and the opening portion of the case body over the entire circumference, wherein in placing the lid, the unmelted opening portion of the case body is placed on a lower side more than a circumferential edge upper surface of an unmelted outer circumferential edge portion of the lid, and in welding, a multi-beam laser beam of a beamlet pattern that provides more heat input to the unmelted opening portion compared to the unmelted outer circumferential edge portion is irradiated to the unmelted outer circumferential edge portion and the unmelted opening portion to laser-weld the outer circumferential edge portion and the opening portion.

The power storage device in this configuration includes the recessed groove in the lid between the outer circumferential edge portion and the inside portion. In the method for manufacturing this power storage device, in the placing process, different from JP2019-084540A, the unmelted opening portion of the case body is positioned on the lower side more than, or below, the circumferential edge upper surface of the lid. In addition, in the welding process, a multi-beam laser beam of the beamlet pattern that provides more input heat to the opening portion than to the outer circumferential edge portion is irradiated to the outer circumferential edge portion and the opening portion to laser-weld the outer circumferential edge portion and the opening portion.

Accordingly, it is possible to deeply melt the opening portion of the case body. Furthermore, when an unmelted outer circumferential edge portion of the lid is melted, a part of molten metal originating from the unmelted outer circumferential edge portion moves toward the opening portion of the case body deeply melted at the lower level. Thus, the molten portion made of molten metal, which results from melting of part of the unmelted opening portion of the case body and part of the unmelted outer circumferential edge portion of the lid, is hardly raided, or have almost no bulge, and the top part of the molten portion is generally horizontal and flat. Therefore, the reflected light of the multi-beam laser beam irradiated to the molten portion does not travel toward the insulation resin member placed in the inside portion of the lid. This can reliably prevent or reduce the occurrence of thermal deterioration, such as scorch, in the insulation resin member.

The tube-shaped case body may have a tube-shape, such as rectangular tube-shape with opening portions at both ends, or alternatively, a bottomed tube-shape with an open one end and the other closed end. Further, the lid has a flat plate-like shape and is placed in the opening portion of the case body. This lid is provided with a recessed groove, which is depressed between the outer circumferential edge portion and the inside portion. This recessed groove may be formed extending in a ring-shape over the entire circumference along the outer circumferential edge portion. As an alternative, another pattern may be adopted in which a recessed groove is not partially provided on the entire circumference between the outer circumferential edge portion and the inside portion.

The multi-beam laser beam refers to a laser beam forming a multi-beam composed of a plurality of beamlets, which are irradiated to an irradiation plane at different sites from each other, forming a plurality of laser spots.

(2) In the foregoing power storage device manufacturing method described in (1), the unmelted opening portion of the case body may have an upward opening end face.

In this configuration, the unmelted opening portion of the case body has the upward opening end face. Thus, the beamlets forming the multi-beam laser beam can be irradiated from above onto the upward opening end face at small incident angles, allowing the opening portion to be more deeply melted.

(3) The foregoing power storage device manufacturing method described in (1) or (2) may be configured such that the circumferential edge upper surface of the unmelted outer circumferential edge portion of the lid includes an outer-circumferential-edge inclined surface located more downward on the outside, and in placing the lid, the unmelted opening portion of the case body is placed on the lower side more than an inclined-surface end, which is a part of the outer-circumferential-edge inclined surface of the unmelted outer circumferential edge portion and located on the outside.

The lid of the power storage device in this configuration includes the outer-circumferential-edge inclined surface as part of the circumferential edge upper surface of the unmelted outer circumferential edge portion. In the placing process, the unmelted opening portion of the case body is placed on the lower side more than, or below, the inclined-surface end of the outer circumferential edge portion. In the welding process, therefore, the reflected light of the laser beam irradiated to the outer-circumferential-edge inclined surface at least at the beginning of melting, of the laser beam irradiated to the circumferential edge upper surface of the unmelted outer circumferential edge portion, is allowed to travel to the outside. Thus, the reflected light does not impinge again on the unmelted opening portion of the case body and travel toward the insulation resin member located on the inside, and thus causes no thermal deterioration of the insulation resin member.

In addition, the reduced volume of the unmelted outer circumferential edge portion by formation of the outer-circumferential-edge inclined surface can further prevent bulging or rising of a molten portion made of molten metal and a melted-solidified portion resulting from solidification of the molten portion.

Furthermore, the unmelted opening portion of the case body is placed on the lower side more than the inclined-surface end of the outer-circumferential-edge inclined surface. This placement allows more molten metal resulting from melting of the unmelted outer circumferential edge portion of the lid to move toward the opening portion of the case body located at a lower level, and further can reduce bulging or rising of the molten portion made of the molten metal to further prevent the reflected light of the multi-beam laser beam from traveling toward the insulation resin member located on the inside.

The outer-circumferential-edge inclined surface may be a flat surface or alternatively a convex surface, such as a semi-cylindrical convex surface that protrudes outward, or a concave surface, such as a semi-cylindrical concave surface that is recessed inward.

On the other hand, the shape of the upper end face of the unmelted opening portion may also be an upward opening end face that entirely faces upward, or alternatively an inclined surface that is entirely inclined outward. Further, this end face may be provided with an outward sloping surface on the outside of the upward opening end face.

(4) In the foregoing power storage device manufacturing method described in any one of (1) to (3), in placing the lid, the unmelted opening portion of the case body may be placed on the lower side more than a bottom of the recessed groove.

In this configuration, the unmelted opening portion of the case body is placed on the lower side more than, or below, the bottom of the recessed groove. This makes it easy for a part of molten metal originating from the unmelted outer circumferential edge portion to move toward the opening portion of the case body at a lower level. Further, when seen from a part of the unmelted outer circumferential edge portion of the lid, located on the upper side, and further on the outside relative to the recessed groove, which is referred herein to as an “unmelted groove outside portion”, the recessed groove is present on the inside and also a space is present on the outside where the unmelted opening portion of the case body is not present. In this unmelted groove outside portion, accordingly, the heat by irradiation of the laser beam is less likely to transfer to both the inside and the outside. Even a small amount of heat input can therefore reliably melt the unmelted groove outside portion.

(5) The foregoing power storage device manufacturing method described in any one of (1) to (4) may be configured such that, in welding, when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary, the plurality of beamlets forming the multi-beam laser beam includes: one or more outer-circumferential-edge-portion-side beamlets to be irradiated to the unmelted outer circumferential edge portion to melt the unmelted outer circumferential edge portion; and one or more opening-portion-side beamlets to be irradiated to the unmelted opening portion to melty the unmelted opening portion, and the beamlet pattern is a beamlet pattern that provides a larger sum of incident energies of all the opening-portion-side beamlets than a sum of incident energies of all the outer-circumferential-edge-portion-side beamlets.

In this configuration, the beamlet pattern of the multi-beam laser beam is designed as a beamlet pattern that provides the total incident energy of all the opening-portion-side beamlets higher than the total incident energy of all the outer-circumferential-edge-portion-side beamlets. This ensures that more heat input can be applied to the opening portion of the case body than to the outer circumferential edge portion of the lid.

(6) The foregoing power storage device manufacturing method described in (5) may be configured such that the plurality of beamlets forming the multi-beam laser beam includes a single inner main beamlet to be irradiated onto the boundary, on a boundary side relative to the outer-circumferential-edge-portion-side beamlets and the opening-portion-side beamlets, the one or more outer-circumferential-edge-portion-side beamlets include one or more outer-circumferential-edge-portion-side leading beamlets that move forward in the first boundary extending direction earlier than the inner main beamlet and melt the unmelted outer circumferential edge portion, the one or more opening-portion-side beamlets include one or more opening-portion-side leading beamlets that move forward in the first boundary extending direction earlier than the inner main beamlet and melt the unmelted opening portion, the inner main beamlet has a higher incident energy than an incident energy of each of the outer-circumferential-edge-portion-side beamlets and the opening-portion-side beamlets, the inner main beamlet is irradiated to a molten portion integrally formed across the boundary from molten metal originating from the unmelted outer circumferential edge portion melted by the outer-circumferential-edge-portion-side leading beamlets and the unmelted opening portion melted by the opening-portion-side leading beamlets.

In this manufacturing method, the inner main beamlet to be irradiated onto the boundary with a highest incident energy is applied to the molten portion. This enables laser welding while reliably preventing the inner main beamlet from passing through the boundary and entering in the case member, causing the occurrence of defects, such as burning or scorching of an electrode body. In addition, the use of the single inner main beamlet having a higher incident energy enables a part of the outer circumferential edge portion of the lid and a part of the opening portion of the case body, near the boundary, to be deeply melted and welded together.

(7) In the foregoing power storage device manufacturing method described in (5) or (6), in welding, at least an unmelted groove outside portion located outside the recessed groove, as part of the unmelted outer circumferential edge portion of the lid, may be entirely melted.

In the welding process of this manufacturing method, at least the entire unmelted groove outside portion, which is a part of the unmelted outer circumferential edge portion of the lid, is melted. This manner enables to easily determine whether the dimension of a weld bead width is appropriate or not based on whether or not the groove outside surface of the recessed groove remains unmelted. Further, this can also stabilize the depth of welding penetration and the volume of the melted-solidified portion.

### BRIEF DESCRIPTION OF THE DRAWINGS

FIG. 1 is a plan view of a battery and an unwelded battery in an embodiment, modified examples 1 and 2, and comparative examples 1 and 2;

FIG. 2 is a longitudinal cross-sectional view of the battery and the unwelded battery in the embodiment, modified examples 1 and 2, and comparative examples 1 and 2;

FIG. 3 is a flowchart showing each step in a laser-welding method in the embodiment, modified examples 1 and 2, and comparative examples 1 and 2;

FIG. 4 is an enlarged cross-sectional explanatory view of the unwelded battery in the embodiment, taken along a line A-A in FIG. 1, showing a state before laser welding, in which a lid is placed in an unmelted opening portion of a case body;

FIG. 5 is an explanatory diagram showing how an opening portion of the case body and an outer circumferential edge portion of the lid are melted and laser-welded together by a multi-beam in the embodiment, modified examples 1 and 2, and comparative examples 1 and 2;

FIG. 6 is an enlarged cross-sectional view of the battery in the embodiment, taken along the line A-A in FIG. 1, showing a state after laser-welding the opening portion of the case body and the outer circumferential edge portion of the lid in the battery;

FIG. 7 is an enlarged cross-sectional view of the unwelded battery in the modified example 1, taken along the line A-A in FIG. 1, showing a state before laser welding, in which the lid is placed in the unmelted opening portion of the case body;

FIG. 8 is an enlarged cross-sectional view of the battery in the modified example 1, taken along the line A-A in FIG. 1, showing a state after laser-welding the opening portion of the case body and the outer circumferential edge portion of the lid;

FIG. 9 is an enlarged cross-sectional view of the unwelded battery in the modified example 2, taken along the line A-A in FIG. 1, showing a state before laser welding, in which the lid is placed in the unmelted opening portion of the case body;

FIG. 10 is an enlarged cross-sectional view of the battery in the modified example 2, taken along the line A-A in FIG. 1, showing a state after laser-welding the opening portion of the case body and the outer circumferential edge portion of the lid;

FIG. 11 is an explanatory diagram showing another beamlet pattern to be used in laser welding;

FIG. 12 is an enlarged cross-sectional view of the unwelded battery in the comparative example 1, taken along the line A-A in FIG. 1, showing a state before laser welding, in which the lid is placed in the unmelted opening portion of the case body;

FIG. 13 is an enlarged cross-sectional view of the battery in the comparative example 1, taken along the line A-A in FIG. 1, showing a state after laser-welding the opening portion of the case body and the outer circumferential edge portion of the lid;

FIG. 14 is an enlarged cross-sectional view of the unwelded battery in the comparative example 2, taken along the line A-A in FIG. 1, showing a state before laser welding, in which the lid is placed in the unmelted opening portion of the case body; and

FIG. 15 is an enlarged cross-sectional view of the battery in the comparative example 2, taken along the line A-A in FIG. 1, showing a state after laser-welding the opening portion of the case body and the outer circumferential edge portion of the lid.

### DETAILED DESCRIPTION OF THE EXEMPLARY EMBODIMENTS

### Embodiment

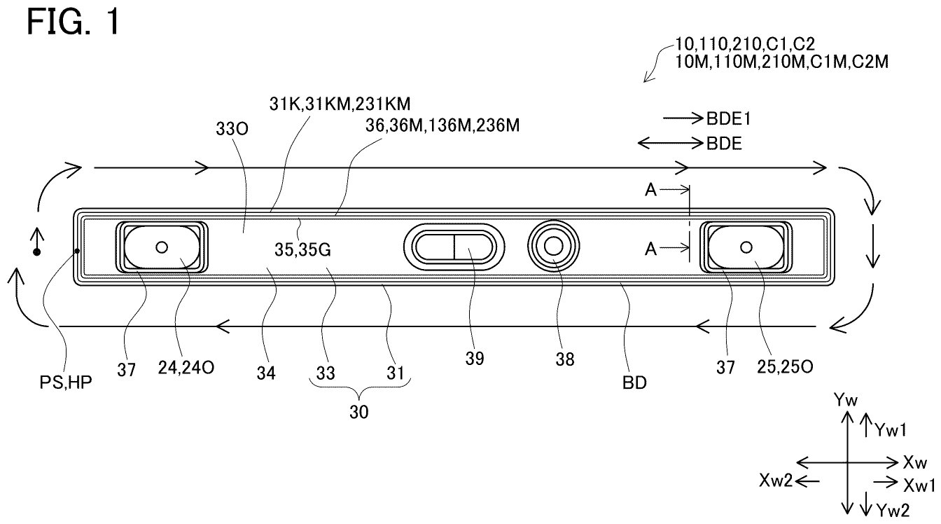

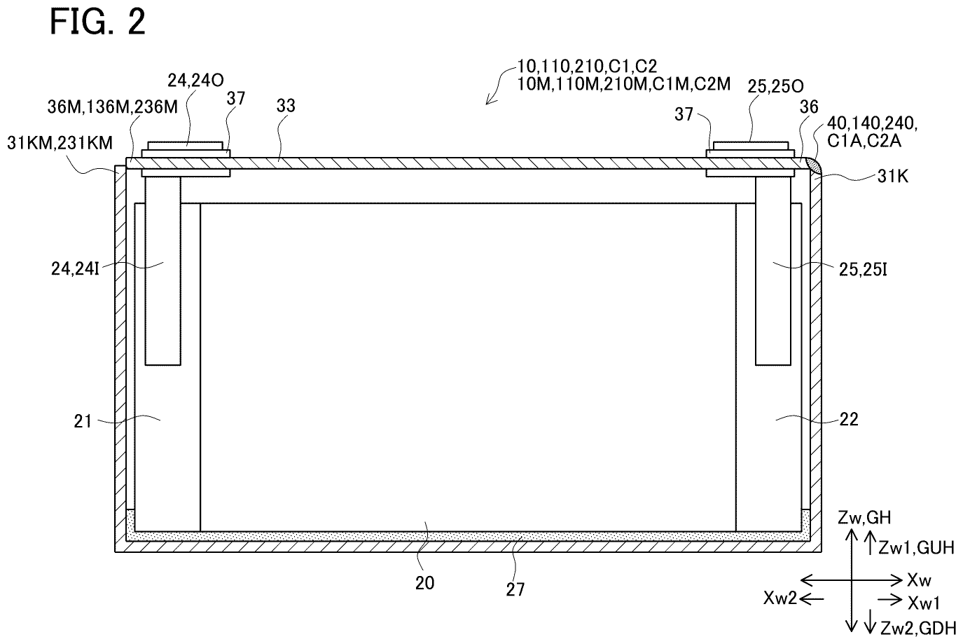

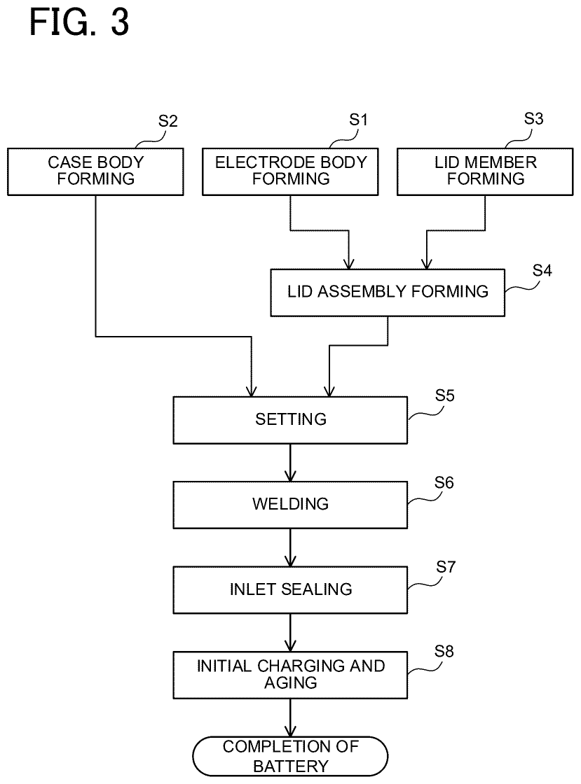

A detailed description of an embodiment of this disclosure will now be given referring to the accompanying drawings. FIG. 1 is a plan view of a battery 10 in the embodiment, FIG. 2 is a longitudinal cross-sectional view of this battery 10, and FIG. 3 is a flowchart showing each step in the process for manufacturing the battery 10.

The battery 10 shown in FIGS. 1 and 2 is a power storage device including a case member 30 made of metal (aluminum in the present embodiment) in a parallelepiped rectangular, or prismatic, shape, in which a well-known wound electrode body 20 and an electrolyte 27 are housed. The case member 30 includes a case body 31 having a bottomed rectangular tube-shape that opens on the upper side, and a rectangular plate-shaped lid 33, which is inserted in an opening portion 31K of the case body 31 and closes the opening portion 31K. The opening portion 31K of the case body 31 and an outer circumferential edge portion 36 of the lid 33 are hermetically joined by a melted-solidified portion 40 (see an upper right portion in FIG. 2) formed by laser welding over their entire circumference. This battery 10 is a secondary battery that can be charged and discharged through a positive terminal 24 and a negative terminal 25, which will be described later, and concretely, a lithium ion secondary battery. In the present embodiment, three perpendicular directions of this battery 10 and an unwelded battery 10M are defined as indicated in FIGS. 1 and 2. Specifically, the long-side direction of the lid 33 is referred to as a work X-direction Xw, the short-side direction of the same is referred to as a work Y-direction Yw, and the depth direction of the case body 31 is referred to as a work Z-direction Zw. Further, in each direction Xw, Yw, Zw, one side Xw1, Yw1, Zw1 and the other side Xw2, Yw2, Zw2 are also defined as indicated in FIGS. 1 and 2.

The electrode body 20 is housed in the case body 31. An inner positive terminal part 24I of the positive terminal 24 is welded to a positive current collector part 21 of the electrode body 20. This positive terminal 24 extends out through the lid 33, forming an outer positive terminal part 24O. Similarly, an inner negative terminal part 25I of the negative terminal 25 is welded to a negative current collector part 22 of the electrode body 20. This negative terminal 25 extends out through the lid 33, forming an outer negative terminal part 25O. Insulation resin member 37 are provided each between the lid 33 and one of the positive terminal 24 and the negative terminal 25 to hermetically insulate them. These insulation resin members 37 are placed on a lid upper surface 33O of the lid 33. Further, the lid 33 is provided with a safety valve 39 near the center and an inlet sealing member 38 sealing a liquid inlet (not shown) between the safety valve 39 and the outer negative terminal part 25O.

The lid 33 of a flat plate shape includes a ring-shaped outer circumferential edge portion 36 located along a circumferential or perimetrical edge, and an inside portion 34 located on the inside LSI relative to the outer circumferential edge portion 36. The lid upper surface 33O, facing to the one side Zw1 in the work Z-direction Zw (upward in FIGS. 2, 4, and 5), is provided with a recessed groove 35G depressed toward the other side Zw2 and circumferentially extending in a ring-shape, between the outer circumferential edge portion 36 and the inside portion 34. The outer circumferential edge portion 36 of the lid 33 and the opening portion 31K of the case body 31 are hermetically laser-welded together over their entire circumference via the melted-solidified portion 40 made of a part of the outer circumferential edge portion 36 and a part of the opening portion 31K, which have been melted and merged, and then solidified.

The process for manufacturing the battery 10 in the embodiment will be described referring to FIG. 3. In an electrode-body forming step S1, the electrode body 20 of a flat wound shape is formed by a well-known method. In parallel with the step S1, in the case-body forming step S2, the case body 31 made of aluminum in a bottomed rectangular tube-shape is formed by a well-known method. Further, in parallel with the above steps S1 and S2, in a lid forming step S3, the lid 33 having a rectangular flat plate shape is formed by a well-known method.

In a lid assembly forming step S4, subsequently, the positive terminal 24 and the negative terminal 25 are integrated with the lid 33 via the insulation resin members 37, and the inner positive terminal part 24I of the positive terminal 24 and the inner negative terminal part 25I of the negative terminal 25 are respectively connected to the positive current collector part 21 and the negative current collector part 22 of the electrode body 20. Thus, a lid assembly (not shown) is completed, in which the electrode body 20 is integrated with the lid 33.

In a placing step S5, the electrode body 20 of the lid assembly is inserted in the case body 31 and then the lid 33 is placed in an unmelted opening portion 31KM of the case body 31. In a welding step S6, subsequently, the outer circumferential edge portion 36 and the opening portion 31K are laser-welded together in a ring shape over their entire circumference. Specifically, a part of an unmelted outer circumferential edge portion 36M of the lid 33 and a part of the unmelted opening portion 31KM of the case body 31 are melted and merged by irradiation of laser, and then solidified to form the melted-solidified portion 40.

In an inlet sealing step S7, the electrolyte 27 is poured into the case member 30 through a liquid inlet (not shown) by a well-known method, so that the electrolyte 27 is impregnated in the electrode body 20. After that, the liquid inlet is sealed with the inlet sealing member 38. In an initial charge and aging step S8, furthermore, the battery 10 is subjected to initial charging and then to high-temperature aging, etc. by a well-known method. Thus, the battery 10 is completed.

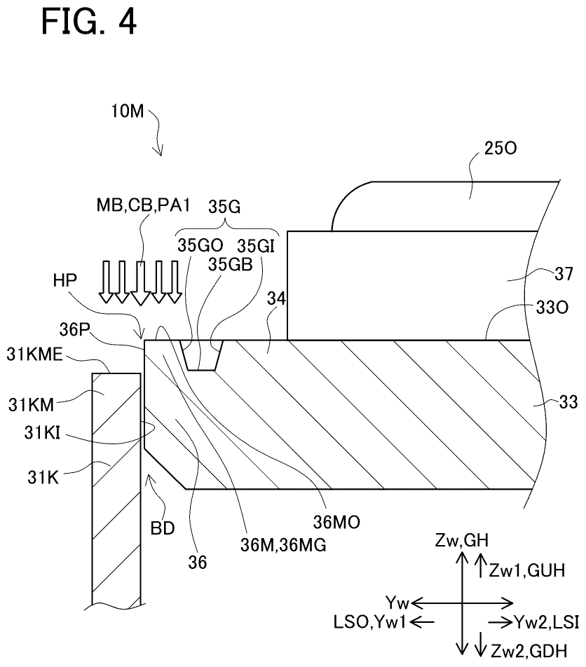

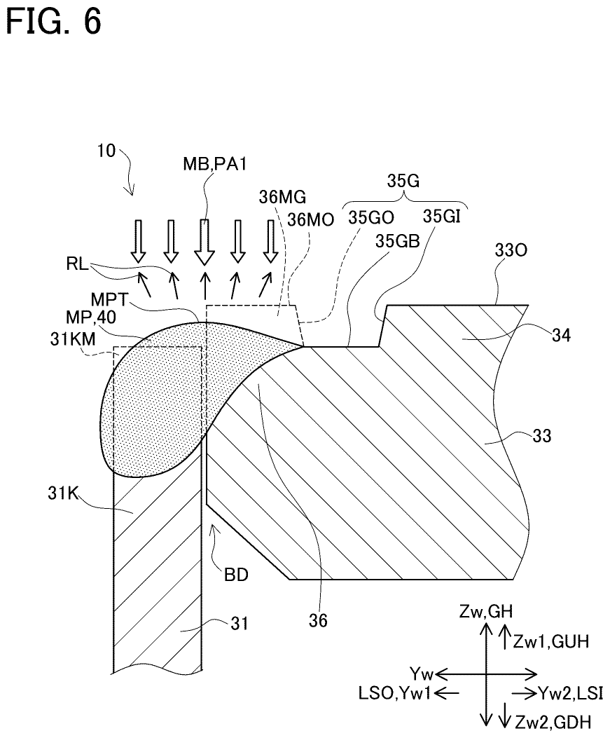

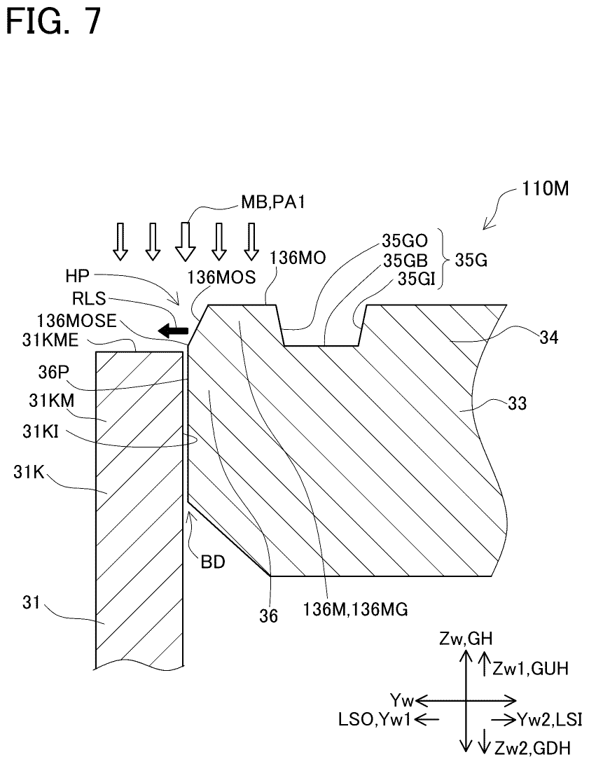

The placing step S5 and the welding step S6 in the process for manufacturing the battery 10 in the embodiment will be described in detail referring to FIGS. 1, 2, and 4 to 6. FIG. 4 is an enlarged cross-sectional view of the unwelded battery 10M in a state before laser welding, taken along a line A-A in FIG. 1. In this figure, the insulation resin member 37 and the outer negative terminal part 25O are visible on the lid upper surface 33O of the lid 33 and on the inside LSI (the other side Yw2 in the work Y-direction Yw, the right side in the figure) relative to the recessed groove 35G. On the other hand, FIG. 6 is an enlarged cross-sectional view of the battery 10 taken along the line A-A in FIG. 1, showing a state after laser welding. However, in FIG. 6, unlike FIG. 4, the insulation resin member 37 and the outer negative terminal part 25O are not illustrated. The same applies to FIGS. 7 to 10 and FIGS. 12 to 15 for modified examples 1 and 2 and comparative examples 1 and 2.

In the placing step S5, as shown in FIG. 4, the lid 33 is placed in the unmelted opening portion 31KM of the case body 31. In the placing step S5 and welding step S6, the unwelded battery 10M is oriented so that the work Z-direction Zw of the unwelded battery 10M coincides with a vertical direction GH. The same applies to unwelded batteries 110M, 210M, C1M, and C2M, which will be mentioned later. Accordingly, the one side Zw1 coincides with an upper side GUH, and the other side Zw2 coincides with a lower side GDH. The unmelted opening portion 31KM of the case body 31 has an upward opening end face 31KME, as an end face, facing upward, i.e., to the upper side GUH. The flat plate-shaped lid 33 has the outer circumferential edge portion 36 (an unmelted outer circumferential edge portion 36M) and the inside portion 34, as described above, and the recessed groove 35G depressed downward, i.e., to the lower side GDH, between the outer circumferential edge portion 36 (the unmelted outer circumferential edge portion 36M) and the inside portion 34. The recessed groove 35G in the embodiment is a trapezoidal groove having a trapezoidal cross-section, including a bottom 35GB, a groove inside surface 35GI inclined and located on the inside LSI relative to the bottom 35GB, and a groove outside surface 35GO inclined and located on the outside LSO relative to the bottom 35GB. Further, a circumferential edge upper surface 36MO, which is the upper surface of the unmelted outer circumferential edge portion 36M, is flush with the lid upper surface 33O.

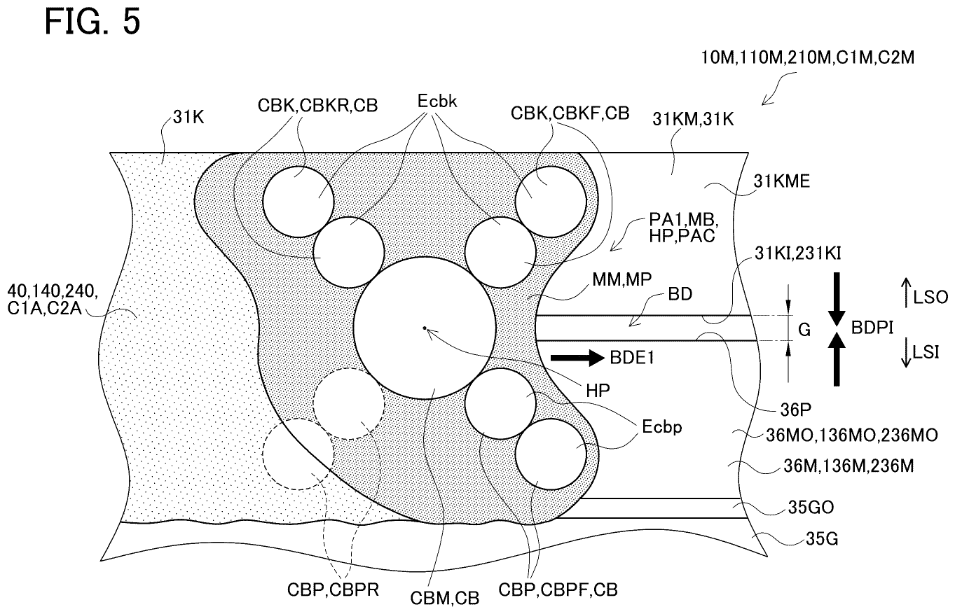

In the placing step S5 in the embodiment, the lid 33 is placed in the case body 31 so that the unmelted opening portion 31KM of the case body 31 is located on the lower side GDH more than, or below, the circumferential edge upper surface 36MO of the unmelted outer circumferential edge portion 36M of the lid 33. Thus, an opening inner peripheral surface 31KI facing to the inside LSI (rightward in FIG. 4), as part of the unmelted opening portion 31KM of the case body 31, and an outer peripheral surface 36P of the outer circumferential edge portion 36 of the lid 33 are positioned facing each other while being in contact with or separated with a slight gap G from each other (see FIG. 5). Also in the modified examples 1 and 2 and comparative examples 1 and 2, in the placing step S5, the lid 33 is placed in the unmelted opening portion 31KM, 231KM of the case body 31 so that the opening inner peripheral surface 31KI and the outer peripheral surface 36P are positioned facing each other while being in contact with or separated with a slight gap G from each other.

In the embodiment, especially, the upward opening end face 31KME of the unmelted opening portion 31KM of the case body 31, hence, the entirety of the unmelted opening portion 31KM of the case body 31, is placed on the lower side GDH more than the bottom 35GB of the recessed groove 35G.

Then, the welding step S6 is performed. In the welding step S6 in the embodiment, a multi-beam MB composed of a plurality of (seven in the embodiment) beamlets CB, which will form a beamlet pattern PA1 mentioned later on an irradiation site HP, is generated by use of a laser welding device not shown. The generated multi-beam MB is irradiated from the upper side GUH above the unwelded battery 10M to the irradiation site HP on the boundary BD between the unmelted opening portion 31KM of the case body 31 and the unmelted outer circumferential edge portion 36M of the lid 33, and further the irradiation site HP is moved, laser-welding the opening portion 31K and the outer circumferential edge portion 36. To be specific, as indicated by arrows in FIG. 1, the irradiation site HP of the multi-beam MB is moved forward from a start point PS in one of boundary extending directions BDE of a rectangular ring-shaped boundary BD, i.e., in a first boundary extending direction BDE1, which is a clockwise direction in plan view in this embodiment, and on the boundary BD to hermetically laser-weld the opening portion 31K and the outer circumferential edge portion 36 over their entire circumference.

One example of a laser welding device used for laser welding may be configured to generate a multi-beam MB by branching a single laser beam generated by a fiber laser or the like into a plurality of beamlets by use of a diffractive optical element (DOE) or a photonic crystal, and additionally include a Z lens for adjusting a focal point in an optical axis direction and an XY scanner unit for deflecting a laser beam. The multi-beam MB may be composed of a plurality of laser beamlets collected and combined.

The present embodiment employs the multi-beam MB composed of seven beamlets CB, forming the beamlet pattern PA1 indicated with solid lines in FIG. 5 on the irradiation site HP. This multi-beam MB includes an inner main beamlet CBM, as one of the beamlets CB, arranged at the center and provides a higher incident energy than other beamlets CB. The multi-beam MB further includes, as the other beamlets CB, one or more (two in the beamlet pattern PA1) outer-circumferential-edge-portion-side beamlets CBP, which are arranged on the inside LSI (a lower side in FIG. 5) relative to the inner main beamlet CBM and is to be irradiated to the unmelted outer circumferential edge portion 36M to melt the unmelted outer circumferential edge portion 36M, and one or more (four in the beamlet pattern PA1) opening-portion-side beamlets CBK, which are arranged on the outside LSO (an upper side in FIG. 5) relative to the inner main beamlet CBM and is to be irradiated to the unmelted opening portion 31KM to melt the unmelted opening portion 31KM.

Six beamlets of the multi-beam MB, i.e., two outer-circumferential-edge-portion-side beamlets CBP and four opening-portion-side beamlets CBK, except for the inner main beamlet CBM, have the same incident energy as each other. Therefore, the multi-beam MB has the beamlet pattern PA1 in which the total incident energy Ecbk (the sum of incident energies) of all of (four) opening-portion-side beamlets CBK is larger than the total incident energy Ecbp (the sum of incident energies) of all of (two) outer-circumferential-edge-portion-side beamlets CBP. Therefore, when irradiated to the irradiation site HP on the boundary BD, the multi-beam MB can apply more heat input to the unmelted opening portion 31KM than to the unmelted outer circumferential edge portion 36M.

In the present embodiment, furthermore, as shown in FIG. 4, the unmelted opening portion 31KM of the case body 31 has the upward opening end face 31KME facing to the upper side GUH. This allows the opening-portion-side beamlets CBK forming the multi-beam MB to be irradiated at a small incident angle from the upper side GUH to the upward opening end face 31KME of the unmelted opening portion 31KM, more deeply melting the opening portion 31K.

The unwelded battery 10M in the present embodiment, as described above, includes the recessed groove 35G between the outer circumferential edge portion 36 (the unmelted outer circumferential edge portion 36M) and the inside portion 34 of the lid 33. In the placing step S5, the unmelted opening portion 31KM of the case body 31 is placed on the lower side GDH more than the circumferential edge upper surface 36MO of the unmelted outer circumferential edge portion 36M of the lid 33. In addition, in the welding step S6, the multi-beam MB of the beamlet pattern PA1 that provides more heat input to the unmelted opening portion 31 KM compared to the unmelted outer circumferential edge portion 36M is irradiated to the unmelted outer circumferential edge portion 36M and the unmelted opening portion 31 KM to laser-weld the outer circumferential edge portion 36 and the opening portion 31K.

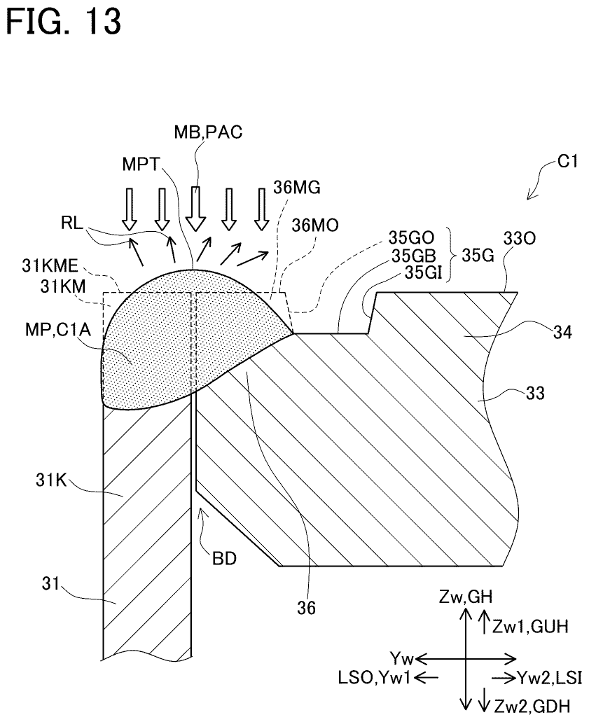

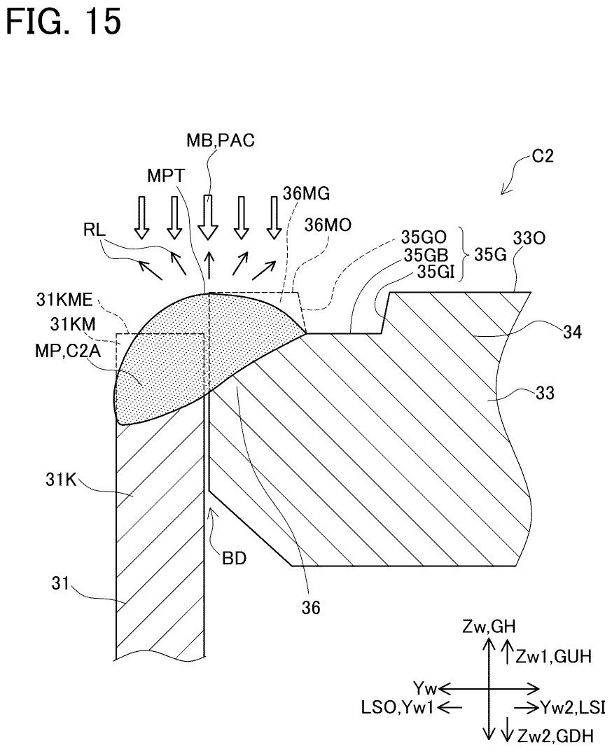

In the above manner, the opening portion 31K of the case body 31 can be more deeply melted. Furthermore, when the unmelted outer circumferential edge portion 36M of the lid 33 is melted, a part of molten metal originating from this unmelted outer circumferential edge portion 36M moves toward the opening portion 31K of the case body 31, which is located at the relatively lower level and deeply melted, that is, to the outside LSO. Consequently, as easily understood by comparison with the comparative examples 1 and 2 (FIGS. 13 and 15) which will be mentioned later, a molten portion MP, made of the molten metal MM resulting from melting of the unmelted opening portion 31KM and the unmelted outer circumferential edge portion 36M, hardly bulges, and thus the top part MPT of the molten portion MP can be generally horizontal and flat (see FIG. 6). Accordingly, the reflected light RL of the multi-beam MB irradiated to the molten portion MP does not travel toward the insulation resin members 37 (not shown in FIG. 6, see FIG. 4) placed on the inside portion 34 of the lid 33. This can reliably prevent or reduce the occurrence of thermal deterioration, such as scorch, of the insulation resin members 37.

In the present embodiment, especially, the unmelted opening portion 31KM of the case body 31 is placed on the lower side GDH more than the bottom 35GB of the recessed groove 35G, as described above. This configuration allows a part of the molten metal MM originating from the unmelted outer circumferential edge portion 36M to move toward the opening portion 31K located at a lower level, i.e., move to the outside LSO. Further, when seen from an unmelted groove outside portion 36MG, which is a part of the unmelted outer circumferential edge portion 36M of the lid 33 and located on the upper side GUH, and further on the outside LSO relative to the recessed groove 35G, the recessed groove 35G is present on the inside LSI and also the space is present on the outside LSO where the unmelted opening portion 31KM of the case body 31 is not present. In this unmelted groove outside portion 36MG, accordingly, the heat by irradiation of the multi-beam MB is less likely to transfer to both the inside LSI and the outside LSO. Even a small amount of heat input by the multi-beam MB can therefore reliably melt the unmelted groove outside portion 36MG.

In the welding step S6 in the present embodiment, at least the entirety of the unmelted groove outside portion 36MG, which is a part of the unmelted outer circumferential edge portion 36M of the lid 33, is melted (see FIGS. 5 and 6). This manner enables to easily determine whether the dimension of a weld bead width is appropriate or not based on whether or not the groove outside surface 35GO of the recessed groove 35G remains unmelted. Further, this can also stabilize the depth of welding penetration and the volume of the melted-solidified portion 40.

The multi-beam MB of the beamlet pattern PA1 shown in FIG. 5 can be said to include the outer-circumferential-edge-portion-side beamlets CBP and the opening-portion-side beamlets CBK, and additionally the single inner main beamlet CBM to be irradiated onto the boundary BD, at a position closer to the boundary center, i.e., on a boundary side BDPI, relative to the other beams CBP and CBP. When the multi-beam MB is moved forward in the first boundary extending direction BDE1 indicated by a thick arrow in FIG. 5, the outer-circumferential-edge-portion-side beamlets CBP include one or more (two in the beamlet pattern PA1) outer-circumferential-edge-portion-side leading beamlets CBPF that move earlier than the inner main beamlet CBM in the first boundary extending direction BDE1 to melt the unmelted outer circumferential edge portion 36M. The opening-portion-side beamlets CBK include one or more (two in the beamlet pattern PA1) opening-portion-side leading beamlets CBKF that move earlier than the inner main beamlet CBM in the first boundary extending direction BDE1 to melt the unmelted opening portion 31KM. Thus, the molten portion MP can be formed integrally across the boundary BD from the molten metal MM originating from the unmelted outer circumferential edge portion 36M melted by the outer-circumferential-edge-portion-side leading beamlets CBPF and the molten metal MM originating from the unmelted opening portion 31KM melted by the opening-portion-side leading beamlets CBKF. Then, it is possible to irradiate the single inner main beamlet CBM to a part of this molten portion MP corresponding to the boundary BD, later than the above leading beamlets CBPF and CBKF

Since the inner main beamlet CBM is irradiated to the molten portion MP made of the molten metal MM as above, laser welding can be performed while reliably preventing or reducing the occurrence of any defects, such as scorching of the electrode body 20, caused by a so-called “laser pass-through” that the inner main beamlet CBM enter the case member 30 by passing through the boundary BD. It is further possible to form the melted-solidified portion 40 by deeply melting a part of the outer circumferential edge portion 36 of the lid 33 and a part of the opening portion 31K of the case body 31, near the boundary BD, by the inner main beamlet CBM (also see FIG. 6).

As shown in FIG. 5, the opening-portion-side beamlets CBK include one or more (two in the beamlet pattern PA1) opening-portion-side trailing beamlets CBKR that travel in the first boundary extending direction BDE1 later than the inner main beamlet CBM to melt the unmelted opening portion 31KM. These trailing beamlets can reduce or eliminate rapid cooling and solidification of the molten portion MP to prevent stress from remaining in the melted-solidified portion 40.

As understood from FIG. 1, in the welding step S6, the multi-beam MB has to be moved forward in the first boundary extending direction BDE1 while maintaining the relationship of the beamlet pattern PA1 of the multi-beam MB with the unmelted opening portion 31KM and the unmelted outer circumferential edge portion 36M as shown in FIG. 5. Then, depending on where the irradiation site HP is located on two long side sections and two short side sections of the rectangular ring-shaped boundary BD, the DOE used in the unillustrated laser welding device may be rotated or a region of the DOE through which a laser beam passes may be changed.

### Modified Example 1

Next, a battery 110 and a method for manufacturing this battery 110 in a modified example 1 will be described referring to FIGS. 1 to 3, 7, and 8. In the unwelded battery 10M of the above-described embodiment, the circumferential edge upper surface 36MO of the unmelted outer circumferential edge portion 36M of the lid 33 is entirely flat (see FIG. 4).

In contrast, an unwelded battery 110M for manufacturing of the battery 110 in the modified example 1 differs from the unwelded battery 10M only in that an unmelted outer circumferential edge portion 136M of the lid 33 is provided with an outer-circumferential-edge inclined surface 136MOS (see FIG. 7). The following description will therefore be given with a focus on the above difference, and similar or identical parts to the embodiment will be omitted or simplified.

In the unwelded battery 110M of the modified example 1, as described above, the shape of the unmelted outer circumferential edge portion 136M which will form the outer circumferential edge portion 36 of the lid 33, especially the shape of an unmelted groove outside portion 136MG, is designed such that a circumferential edge upper surface 136MO includes the outer-circumferential-edge inclined surface 136MOS located more downward (toward the lower side GDH) on the outside LSO (left side in FIG. 7). The outer-circumferential-edge inclined surface 136MOS of the lid 33 may be formed by press forming.

In the placing step S5, the unmelted opening portion 31KM of the case body 31 is placed on the lower side GDH more than, or below, an inclined-surface end 136MOSE which is a part of the outer-circumferential-edge inclined surface 136MOS and located on the outside LSO (see FIG. 7).

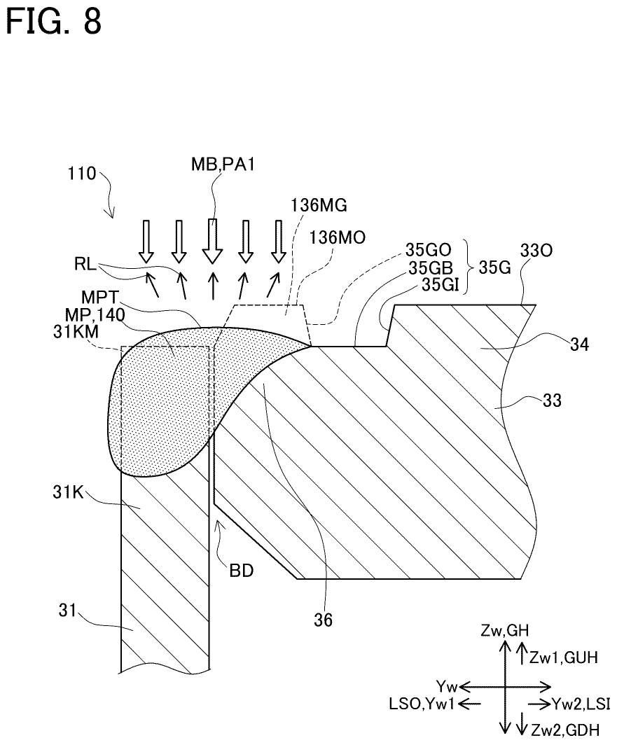

In the welding step S6, then, the inclined-surface reflected light RLS of the laser beam irradiated to the outer-circumferential-edge inclined surface 136MOS at least at the beginning of melting, of the multi-beam MB irradiated to the circumferential edge upper surface 136MO of the unmelted outer circumferential edge portion 136M, is allowed to travel to the outside LSO as indicated by a thick arrow in FIG. 7. This inclined-surface reflected light RLS does not impinge again on the unmelted opening portion 31KM of the case body 31 and does not travel toward the insulation resin member 37 (not shown in FIG. 7, see FIG. 4) on the inside LSI (rightward in FIG. 7), and thus cause no thermal deterioration of the insulation resin member 37. In addition, the reduced volume of the unmelted outer circumferential edge portion 136M by formation of the outer-circumferential-edge inclined surface 136MOS can further prevent bulging or rising of the molten portion MP made of the molten metal MM and the melted-solidified portion 140 resulting from solidification of the molten portion MP, as shown in FIG. 8.

Furthermore, the unmelted opening portion 31KM of the case body 31 is placed on the lower side GDH more than, or below, the inclined-surface end 136MOSE of the circumferential edge upper surface 136MO. This makes it easy for the molten metal MM, which results from melting of the unmelted outer circumferential edge portion 136M of the lid 33, to move toward the opening portion 31K of the case body 31 located at a lower level, i.e., to the outside LSO, and further can reduce bulging or rising of the molten portion MP made of the molten metal MM to make the top part MPT of the molten portion MP generally horizontal and flat. Thus, it is possible to prevent or reduce the reflected light RL of the multi-beam MB from traveling toward the insulation resin member 37 on the inside LSI.

Also in the unwelded battery 110M in the modified example 1, the unmelted opening portion 31KM of the case body 31 is placed on the lower side GDH more than the bottom 35GB of the recessed groove 35G. This makes it easy for a part of the molten metal MM originating from the unmelted outer circumferential edge portion 136M to move toward the opening portion 31K at the lower level, i.e., to the outside LSO. Further, in the unmelted groove outside portion 136MG located on the upper side GUH and the outside LSO of the recessed groove 35G, in the unmelted outer circumferential edge portion 136M of the lid 33, heat is less likely to transfer to both the inside LSI and the outside LSO. Even a small amount of heat input by the multi-beam MB can therefore reliably melt the unmelted groove outside portion 136MG.

### Modified Example 2

Next, a battery 210 and a method for manufacturing this battery 210 in a modified example 2 will be described referring to FIGS. 1 to 3, 9, and 10. In the unwelded battery 110M of the modified example 1, the unmelted outer circumferential edge portion 136M of the lid 33 is provided with the outer-circumferential-edge inclined surface 136MOS, and the unmelted opening portion 31KM of the case body 31 has the upward opening end face 31KME facing to the upper side GUH, similar to the unwelded battery 10M in the embodiment (see FIGS. 4 and 7).

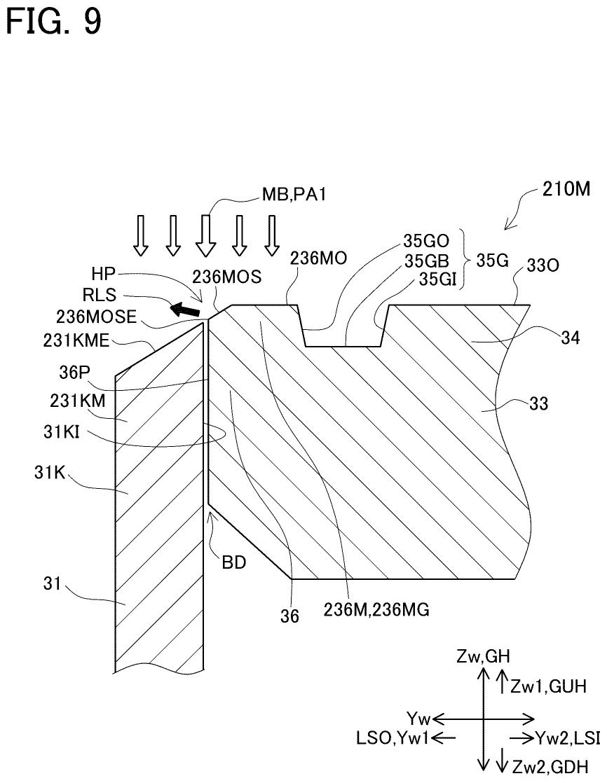

In contrast, an unwelded battery 210M for manufacturing of the battery 210 in the modified example 2 differs from the unwelded battery 10M in that an unmelted outer circumferential edge portion 236M of the lid 33 is provided with an outer-circumferential-edge inclined surface 236MOS as with the unwelded battery 110M of the modified example 1, and additionally that an unmelted opening portion 231KM of the case body 31 is made as an opening end inclined surface 231KME facing to the upper side GUH and the outside LSO (see FIG. 9). The following description will therefore be given with a focus on the above difference, and similar or identical parts to the embodiment will be omitted or simplified.

In the unwelded battery 210M of the modified example 2, as described above, as with the unwelded battery 110M of the modified example 1, the shape of the unmelted outer circumferential edge portion 236M which will form the outer circumferential edge portion 36 of the lid 33, especially the shape of the unmelted groove outer portion 236MG, is designed such that a circumferential edge upper surface 236MO includes an outer-circumferential-edge inclined surface 236MOS located more downward (toward the lower side GDH) on the outside LSO (left side in FIG. 9). In the placing step S5, the unmelted opening portion 231KM of the case body 31 is entirely placed on the lower side GDH more than, or below, an inclined-surface end 236MOSE, which is a part of the outer-circumferential-edge inclined surface 236MOS and located on the outside LSO.

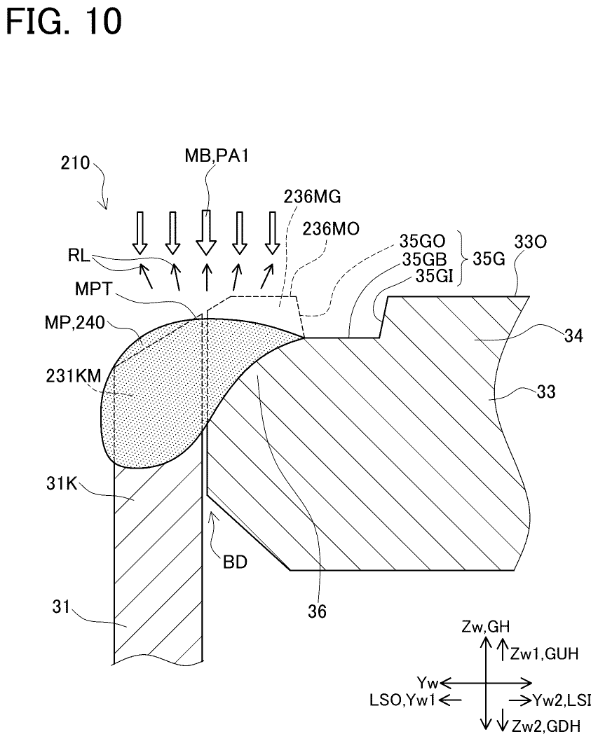

In the welding step S6, then, the inclined-surface reflected light RLS of the laser beam irradiated to the outer-circumferential-edge inclined surface 236MOS at least at the beginning of melting, of the multi-beam MB irradiated to the circumferential edge upper surface 236MO of the unmelted outer circumferential edge portion 236M, is allowed to travel to the outside LSO as indicated by a thick arrow in FIG. 9. This inclined-surface reflected light RLS does not impinge again on the unmelted opening portion 231KM of the case body 31 and does not travel toward the insulation resin member 37 (not shown in FIG. 9, see FIG. 4) on the inside LSI (rightward in FIG. 7), and thus cause no thermal deterioration of the insulation resin member 37. In addition, the reduced volume of the unmelted outer circumferential edge portion 236M by formation of the outer-circumferential-edge inclined surface 236MOS can further prevent bulging or rising of the molten portion MP made of the molten metal MM and the melted-solidified portion 240 resulting from solidification of the molten portion MP, as shown in FIG. 10.

Furthermore, the unmelted opening portion 231KM of the case body 31 is placed on the lower side GDH more than the inclined-surface end 236MOSE of the outer-circumferential-edge inclined surface 236MOS. This makes it easy for the molten metal MM, which results from melting of the unmelted outer circumferential edge portion 236M of the lid 33, to move toward the opening portion 31K of the case body 31 located at a lower level, i.e., to the outside LSO, and further can reduce bulging or rising of the molten portion MP made of the molten metal MM and further reduce the reflected light RL of the multi-beam MB from traveling toward the insulation resin member 37 on the inside LSI.

In addition, in the unwelded battery 210M of the modified example 2, the end face of the unmelted opening portion 231KM of the case body 31 is formed as the opening end inclined surface 231KME facing to the upper side GUH and the outside LSO. Thus, compared to the end face of the unmelted opening portion 231KM, formed as an upward opening end face, it is possible to move more molten metal MM, which results from melting of the unmelted outer circumferential edge portion 236M of the lid 33, toward the opening portion 31K of the case body 31 at a lower level, i.e., to the outside LSO, and reduce bulging or rising of the molten portion MP made of the molten metal MM and further reduce the reflected light RL of the multi-beam MB from traveling toward the insulation resin member 37 on the inside LSI.

In the unwelded battery 210M of the modified example 2, the entire end face of the unmelted opening portion 231KM of the case body 31 is formed as the opening end inclined surface 231KME providing a sloping surface. However, as with the outer-circumferential-edge inclined surface 136MOS of the unmelted outer circumferential edge portion 136M of the lid 33, for example, the end face of the unmelted opening portion 231KM may be configured such that a part of the end face forms an upward opening end face facing to the upper side GUH and only a part of remaining area on the outside LSO forms an inclined surface.

In the unwelded battery 210M of the modified example 2, unlike the embodiment and the modified example 1, the unmelted opening portion 231KM of the case body 31 is not placed on the lower side GDH relative to the bottom 35GB of the recessed groove 35G. However, the unmelted opening portion 231KM of the case body 31 may be placed on the lower side GDH relative to the bottom 35GB of the recessed groove 35Gin consideration of the range and the angle of the inclined surface: for example, only a part of the end face of the unmelted opening portion 231KM is formed as an inclined surface. In this case, a part of the molten metal MM originating from the unmelted outer circumferential edge portion 236M is easily moved toward the opening portion 31K at a lower level, that is, to the outside LSO. Further, in the unmelted outer circumferential edge portion 236M of the lid 33, the unmelted groove outer portion 236 MG located on the upper side GUH and the outside LSO of the recessed groove 35G can be more reliably melted.

### Other Beamlet Patterns

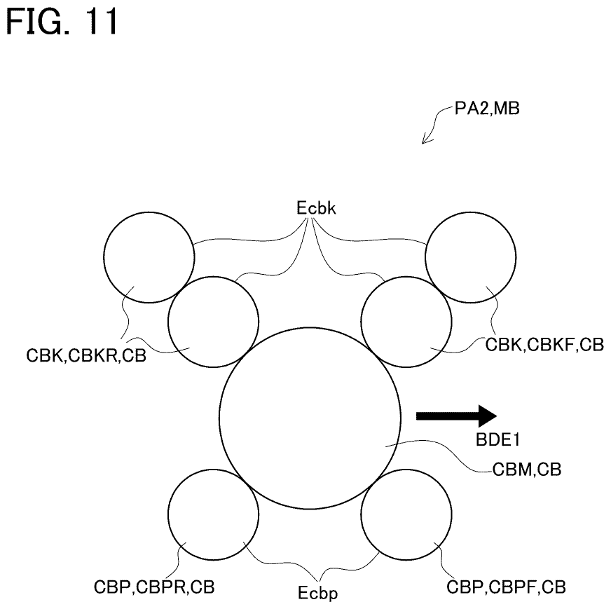

For manufacturing of the batteries 10, 110, and 210 in the embodiment, modified examples 1 and 2, in the welding step S6, the multi-beam MB of the beamlet pattern PA1 with seven beamlets CB indicated by solid lines in FIG. 5 is generated to perform laser welding. However, the available beamlet pattern for the multi-beam MB is not limited to the beamlet pattern PA1 indicated by the solid lines in FIG. 5. For example, a multi-beam MB of a beamlet pattern PA2 with seven beamlets CB shown in FIG. 11 may be adopted.

The multi-beam MB of the beamlet pattern PA2 shown in FIG. 11 also includes a single inner main beamlet CBM, as one of the beamlets CB, arranged at the center and provides a higher incident energy than other beamlets CB. The multi-beam MB further includes, as the other beamlets CB, one or more (two in the beamlet pattern PA2) outer-circumferential-edge-portion-side beamlets CBP, which are arranged on the inside LSI (a lower side in FIG. 11) relative to the inner main beamlet CBM and to be irradiated to the unmelted outer circumferential edge portion 36M, 136M, 236M to melt this unmelted outer circumferential edge portion 36M, 136M, 236M and one or more (four in the beamlet pattern PA2) opening-portion-side beamlets CBK, which are arranged on the outside LSO (an upper side in FIG. 11) and to be irradiated to the unmelted opening portion 31KM, 231KM to melt the unmelted opening portion 31KM, 231KM.

Six beamlets of the multi-beam MB of the beamlet pattern PA2, i.e., two outer-circumferential-edge-portion-side beamlets CBP and four opening-portion-side beamlets CBK, except for the inner main beamlet CBM, have the same incident energy as each other. Therefore, in the multi-beam MB of the beamlet pattern PA2, the total incident energy Ecbk (the sum of incident energies) of all of (four) opening-portion-side beamlets CBK is larger than the total incident energy Ecbp (the sum of incident energies) of all of (two) outer-circumferential-edge-portion-side beamlets CBP. Therefore, when irradiated to the irradiation site HP on the boundary BD, the multi-beam MB of the beamlet pattern PA2 can apply more heat input to the unmelted opening portion 31KM, 231KM than to the unmelted outer circumferential edge portion 36M, 136M, 236M.

Furthermore, also in the multi-beam MB of the beamlet pattern PA2 shown in FIG. 11, as with the multi-beam MB of the beamlet pattern PA1 shown in FIG. 5, the outer-circumferential-edge-portion-side beamlets CBP include one or more (one in the beamlet pattern PA2) outer-circumferential-edge-portion-side leading beamlets CBPF that is moved forward earlier than the inner main beamlet CBM and melt the unmelted outer circumferential edge portion 36M and others. The opening-portion-side beamlets CBK include one or more (two in the beamlet pattern PA2) opening-portion-side leading beamlets CBKF that moves forward earlier than the inner main beamlet CBM and melt the unmelted opening portion 31KM. Thus, the molten portion MP can be formed integrally across the boundary BD from the molten metal MM originating the unmelted outer circumferential edge portion 36M and the unmelted opening portion 31KM melted by the leading beamlets CBPF and CBKF in advance of the inner main beamlet CBM. The single inner main beamlet CBM can thus be irradiated to a part of the molten portion MP corresponding to the boundary BD. With the multi-beam MB of the beamlet pattern PA2, laser welding can also be performed while reliably preventing the occurrence of any defects caused by a so-called “laser pass-through”. In addition, a part of the outer circumferential edge portion 36 of the lid 33 and a part of the opening portion 31K of the case body 31, near the boundary BD, can be more deeply melted and formed into the melted-solidified portion 40, 140, 240 (also see FIGS. 6, 8, and 10).

### Comparative Example 1

Next, a battery C1 and a method for manufacturing the battery C1 in a comparative example 1 will be described referring to FIGS. 1 to 3, 12, and 13. For the unwelded battery 10M of the embodiment, when the lid 33 is placed in the case body 31, the unmelted opening portion 31KM of the case body 31 is positioned on the lower side GDH more than the circumferential edge upper surface 36MO of the unmelted outer circumferential edge portion 36M of the lid 33 (see FIG. 4). In addition, in the welding step S6, laser welding is performed using the multi-beam MB of the beamlet pattern PA1 composed of seven beamlets CB, as shown with solid lines in FIG. 5, to provide more heat input to the unmelted opening portion 31KM compared to the unmelted outer circumferential edge portion 36M, forming the molten portion MP that is hardly raised and has the generally horizontal and flat top part MPT, and the melted-solidified portion 40 resulting from solidification of the molten portion MP.

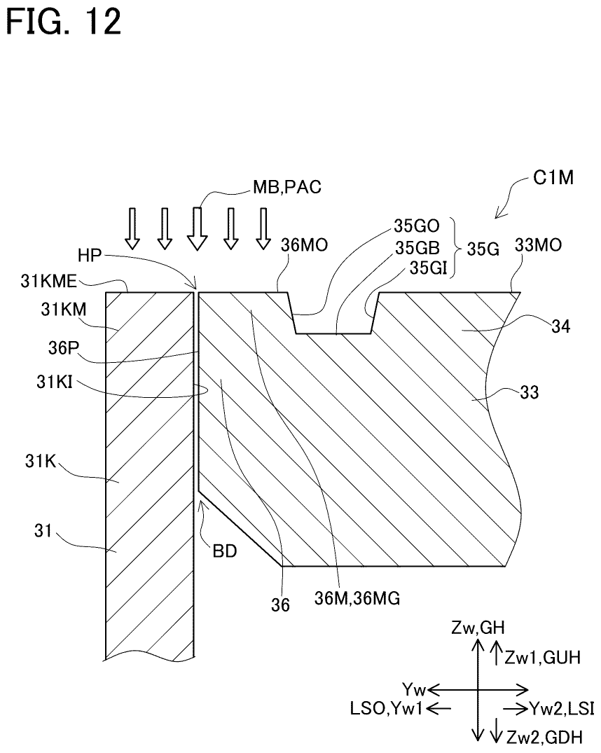

In contrast, the comparative example 1 shown in FIG. 12 employs an unwelded battery C1M including the case body 31 and the lid 33 identical to those of the unwelded battery 10M of the embodiment; however, the unmelted opening portion 31KM of the case body 31 and the outer circumferential edge portion 36 of the lid 33 are placed at the same height or level, that is, the upward opening end face 31KME of the unmelted opening portion 31KM of the case body 31 and the circumferential edge upper surface 36MO of the unmelted outer circumferential edge portion 36M of the lid 33 are positioned to be flush with each other.

In the comparative example 1, further, in the welding step S6, laser welding is performed using a multi-beam MB of a beamlet pattern PAC to obtain the battery C1. This beamlet pattern PAC is composed of nine beamlets CB arranged in an X-shape, which includes seven beamlets CB of the beamlet pattern PA1 indicated by solid lines in FIG. 5 and additionally two beamlets CB indicated by broken lines in FIG. 5, that is, two outer-circumferential-edge-portion-side trailing beamlets CBPR. This beamlet pattern PAC provides heat input with the same heat amount to the unmelted outer circumferential edge portion 36M and the unmelted opening portion 31KM.

In the battery C1 of the comparative example 1, as shown in FIG. 13, the molten portion MP and a melted-solidified portion C1A resulting from solidification of the molten portion MP are largely raised in a semi-circular cross section with its top part MPT located on the upper side GUH than the upward opening end face 31KME and the circumferential edge upper surface 36MO. Therefore, in the battery C1, unlike the batteries 10, 110, and 210 of the embodiment, comparative examples 1 and 2, part of the reflected light RL of the multi-beam MB irradiated to the molten portion MP travels toward the insulation resin member 37 (not illustrated in FIG. 13, see FIG. 4) placed in the inside portion 34 of the lid 33, as indicated by arrows in FIG. 13, causing scorching and other thermal deterioration of the insulation resin member 37.

### Comparative Example 2

Next, a battery C2 and a method for manufacturing the battery C2 in a comparative example 2 will be described referring to FIGS. 1 to 3, 14, and 15. The embodiment employs the unwelded battery 10M configured such that the lid 33 is placed in the case body 31 so that the unmelted opening portion 31KM of the case body 31 is positioned on the lower side GDH more than the circumferential edge upper surface 36MO of the unmelted outer circumferential edge portion 36M of the lid 33 (see FIG. 4). In addition, in the welding step S6, laser welding is performed using the multi-beam MB of the beamlet pattern PA1 composed of seven beamlets CB, as shown with solid lines in FIG. 5, to provide more heat input to the unmelted opening portion 31KM compared to the unmelted outer circumferential edge portion 36M, forming the molten portion MP that are hardly raised and has the generally horizontal and flat top part MPT, and the melted-solidified portion 40 resulting from solidification of the molten portion MP.

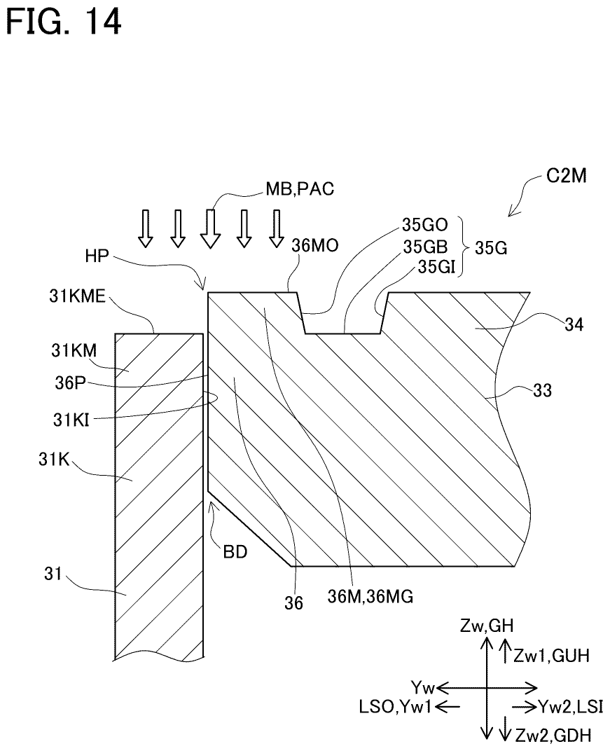

In contrast, the comparative example 2 shown in FIG. 14 employs an unwelded battery C2M including the case body 31 and the lid 33 placed in the same manner as in the unwelded battery 10M of the above-mentioned embodiment. However, for laser welding on the unwelded battery C2M to produce the battery C2, the laser welding is performed using the multi-beam MB of the beamlet pattern PAC as in the comparative example 1, different from the embodiment using the multi-beam MB of the beamlet pattern PA1 (see FIG. 5). This beamlet pattern PAC is composed of nine beamlets CB arranged in an X-shape to provide heat input with the same heat amount to the unmelted outer circumferential edge portion 36M and the unmelted opening portion 31KM. Specifically, the comparative example 1 is different from the embodiment only in the beamlet pattern of the multi-beam to be irradiated.

In the battery C2 of the comparative example 2, as shown in FIG. 15, the molten portion MP and a melted-solidified portion C2A resulting from solidification of the molten portion MP are not as greatly raised as the molten portion MP and the melted-solidified portion C1A of the battery C1 of the comparative example 1, but are largely raised in a semi-circular cross section with its top part MPT located at the same level as the upward opening end face 31KME and the circumferential edge upper surface 36MO. Therefore, in the battery C2 of the comparative example 2, unlike the batteries 10, 110, and 210 of the embodiment, comparative examples 1 and 2, part of the reflected light RL of the multi-beam MB irradiated to the molten portion MP travels toward the insulation resin member 37 (not illustrated in FIG. 15, see FIG. 4) placed in the inside portion 34 of the lid 33, as indicated by arrows in FIG. 15, causing scorching and other thermal deterioration of the insulation resin member 37.

As understood from comparison of the battery 10 of the embodiment shown in FIG. 6 with the battery C1 of the comparative example 1 shown in FIG. 13 and the battery C2 of the comparative example 2 shown in FIG. 15, as in the unwelded battery 10M of the embodiment, the unmelted opening portion 31KM of the case body 31 is placed on the lower side GDH more than the circumferential edge upper surface 36MO of the outer circumferential edge portion 36 of the lid 33 (see FIG. 4). In addition, more heat input is provided to the unmelted opening portion 31KM compared to the unmelted outer circumferential edge portion 36M to more deeply melt the opening portion 31K of the case body 31. The above manner allows part of the molten metal MM originating from the unmelted outer circumferential edge portion 36M to move toward the opening portion 31K of the case body 31 (the outside LSO) deeply melted at a relatively lower level. This can form the molten portion MP in a flat shape that is hardly raised, made of the molten metal MM resulting from melting of the unmelted opening portion 31KM and the unmelted outer circumferential edge portion 36M. It is accordingly found that this can reliably reduce the occurrence of thermal degradation of the resin member 37 caused by the reflected light RL of the multi-beam MB irradiated.

The foregoing embodiment, modified examples 1 and 2 are mere examples and give no limitation to the present disclosure. The present disclosure may be embodied in other specific forms without departing from the essential characteristics thereof.

### REFERENCE SIGNS LIST

MB Multi-beam (Multi-beam laser beam)
CB Sub-beam
CBM Inner main beamlet
CBP Outer-circumferential-edge-portion-side beamlet
Ecbp Total incident energy (of outer-circumferential-edge-portion-side beamlets)
CBPF Outer-circumferential-edge-portion-side leading beamlet
CBK Opening-portion-side beamlet
Ecbk Total incident energy (of opening-portion-side beamlets)
CBKF Opening-portion-side leading beamlet
PA1, PA2, PAC Beam pattern
HP Irradiation site
MM Molten metal
MP Molten portion
10, 110, 210, C1, C2 Battery (Power storage device)
10M, 110M, 210M, C1M, C2M Unwelded battery
30 Case member
31 Case body
31K Opening portion
31KM, 231KM Unmelted opening portion
31KI Opening inner peripheral surface
31KME Upward opening end face (of unmelted opening portion)
231KME Opening end inclined surface (of unmelted opening portion)
33 Lid
33O Lid upper surface
34 Inside portion
35G Recessed groove
35GB Bottom
36 Outer circumferential edge portion
36M, 136M, 236M Unmelted outer circumferential edge portion
36P Outer peripheral surface
36MO, 136MO, 236MO Circumferential edge upper surface (of unmelted outer circumferential edge portion)
136MOS, 236MOS Outer-circumferential-edge inclined surface
136MOSE, 236MOSE Inclined-surface end (of outer-circumferential-edge inclined surface)
36MG, 136MG, 236MG Unmelted groove outside portion
GUH Upper side
GDH Lower side
LSO Outside
LSI Inside
37 Insulation resin member (Resin member)
40, 140, 240, C1A, C2A Melted-solidified portion
BD Boundary
BDE Boundary extending direction
BDE1 First boundary extending direction
BDPI Boundary side
S5 Placing step
S6 Welding step

What is claimed is:

1. A method for manufacturing a power storage device comprising:
a case member made of metal; and
an electrode body housed in the case member,
the case member including:
a case body having a tube shape with an opening portion;
a lid having a flat plate shape, placed in the opening portion of the case body, the lid including:
an outer circumferential edge portion; and
an inside portion located more inside than the outer circumferential edge portion,
a recessed groove, which is depressed in a lid upper surface between the outer circumferential edge portion and the inside portion; and
an insulation resin member placed on the lid upper surface of the inside portion of the lid, and
the outer circumferential edge portion of the lid and the opening portion of the case body are welded to each other over an entire circumference via a melted-solidified portion formed by a part of the outer circumferential edge portion and a part of the opening portion that are melted together and then solidified,
wherein the method comprises:
placing the lid in an unmelted opening portion of the case body; and
welding the outer circumferential edge portion of the lid and the opening portion of the case body over the entire circumference,
wherein in placing the lid, the unmelted opening portion of the case body is placed on a lower side more than a circumferential edge upper surface of an unmelted outer circumferential edge portion of the lid, and
in welding, a multi-beam laser beam of a beamlet pattern that provides more heat input to the unmelted opening portion compared to the unmelted outer circumferential edge portion is irradiated to the unmelted outer circumferential edge portion and the unmelted opening portion to laser-weld the outer circumferential edge portion and the opening portion.

2. The method for manufacturing a power storage device, according to claim 1, wherein the unmelted opening portion of the case body has an upward opening end face.

3. The method for manufacturing a power storage device, according to claim 1, wherein
the circumferential edge upper surface of the unmelted outer circumferential edge portion of the lid includes an outer-circumferential-edge inclined surface located more downward on the outside, and
in placing the lid, the unmelted opening portion of the case body is placed on the lower side more than an inclined-surface end, which is a part of the outer-circumferential-edge inclined surface of the unmelted outer circumferential edge portion and located on the outside.

4. The method for manufacturing a power storage device according to claim 2, wherein
the circumferential edge upper surface of the unmelted outer circumferential edge portion of the lid includes an outer-circumferential-edge inclined surface located more downward on the outside, and
in placing the lid, the unmelted opening portion of the case body is placed on the lower side more than an inclined-surface end, which is a part of the outer-circumferential-edge inclined surface of the unmelted outer circumferential edge portion and located on the outside.

5. The method for manufacturing a power storage device, according to claim 1, wherein, in placing the lid, the unmelted opening portion of the case body is placed on the lower side more than a bottom of the recessed groove.

6. The method for manufacturing a power storage device according to claim 2, wherein in placing the lid, the unmelted opening portion of the case body is placed on the lower side more than a bottom of the recessed groove.

7. The method for manufacturing a power storage device according to claim 3, wherein in placing the lid, the unmelted opening portion of the case body is placed on the lower side more than a bottom of the recessed groove.

8. The method for manufacturing a power storage device according to claim 4, wherein in placing the lid, the unmelted opening portion of the case body is placed on the lower side more than a bottom of the recessed groove.

9. The method for manufacturing a power storage device, according to claim 1, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

10. The method for manufacturing a power storage device according to claim 2, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

11. The method for manufacturing a power storage device according to claim 3, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

12. The method for manufacturing a power storage device according to claim 4, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

13. The method for manufacturing a power storage device according to claim 5, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

14. The method for manufacturing a power storage device according to claim 6, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

15. The method for manufacturing a power storage device according to claim 7, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

16. The method for manufacturing a power storage device according to claim 8, wherein
in welding,
when the multi-beam laser beam is irradiated to a ring-shaped boundary between the unmelted opening portion and the unmelted outer circumferential edge portion and an irradiation site of the multi-beam laser beam is moved forward in a first boundary extending direction, which is one of boundary extending directions of the boundary,
the plurality of beamlets forming the multi-beam laser beam includes:
one or more outer-circumferential-edge-portion-side beamlets to be irradiated to the unmelted outer circumferential edge portion to melt the unmelted outer circumferential edge portion; and
one or more opening-portion-side beamlets to be irradiated to the unmelted opening portion to melty the unmelted opening portion, and
the beamlet pattern is a beamlet pattern that provides a larger sum of incident energies of all the opening-portion-side beamlets than a sum of incident energies of all the outer-circumferential-edge-portion-side beamlets.

17. The method for manufacturing a power storage device, according to claim 9, wherein
the plurality of beamlets forming the multi-beam laser beam includes a single inner main beamlet to be irradiated onto the boundary, on a boundary side* relative to the outer-circumferential-edge-portion-side beamlets and the opening-portion-side beamlets,
the one or more outer-circumferential-edge-portion-side beamlets include one or more outer-circumferential-edge-portion-side leading beamlets that move forward in the first boundary extending direction earlier than the inner main beamlet and melt the unmelted outer circumferential edge portion,
the one or more opening-portion-side beamlets include one or more opening-portion-side leading beamlets that move forward in the first boundary extending direction earlier than the inner main beamlet and melt the unmelted opening portion,
the inner main beamlet has a higher incident energy than an incident energy of each of the outer-circumferential-edge-portion-side beamlets and the opening-portion-side beamlets,
the inner main beamlet is irradiated to a molten portion integrally formed across the boundary from molten metal originating from the unmelted outer circumferential edge portion melted by the outer-circumferential-edge-portion-side leading beamlets and the unmelted opening portion melted by the opening-portion-side leading beamlets.

18. The method for manufacturing a power storage device, according to claim 9, wherein, in welding, at least an unmelted groove outside portion located outside the recessed groove, as part of the unmelted outer circumferential edge portion of the lid, is entirely melted.
